(19) United States
(12) Patent Application Publication
(10) Pub. No.: US 2007/0162433 A1
(43) Pub. Date: Jul. 12, 2007

(54) SYSTEM AND METHOD FOR A SECURE PROCESS TO PERFORM DISTRIBUTED TRANSACTIONS

(76) Inventor: James D. Peters, Alpharetta, GA (US)

Correspondence Address: MCGUIREWOODS, LLP, 1750 TYSONS BLVD, SUITE 1800, MCLEAN, VA, 22102, US

(21) Appl. No.: 11/622,435

(22) Filed: Jan. 11, 2007

Related U.S. Application Data
(60) Provisional application No. 60/758,325, filed on Jan. 11, 2006.
(60) Provisional application No. 60/758,395, filed on Jan. 11, 2006.
(60) Provisional application No. 60/758,433, filed on Jan. 11, 2006.
(60) Provisional application No. 60/758,283, filed on Jan. 11, 2006.

(51) Int. Cl. G06F 17/30; G06F 19/00

(52) U.S. Cl. 707/3; 705/3

(57) ABSTRACT

An interoperable process and system for an automated secure information exchange. The secure processing system is capable of efficiently extending interoperability for communications and data related to transactions to business entities in an overall business sector, such as healthcare.

### CROSS-REFERENCE TO RELATED APPLICATIONS

This application claims the benefit of U.S. Provisional Patent Application No. 60/758,325, U.S. Provisional Patent Application No. 60/758,395, U.S. Provisional Patent Application No. 60/758,433 and U.S. Provisional Patent Application No. 60/758,283, each of which were filed on Jan. 11, 2006, and are incorporated by reference herein, in their entirety. Further, this application is related to U.S. patent application No. ______, entitled “TOOLBAR USER INTERFACE FOR INFORMATION SYSTEM,” U.S. patent application Ser. No. ______, entitled “SYSTEM AND METHODS FOR PERFORMING DISTRIBUTED TRANSACTIONS,” and U.S. patent application Ser. No. ______, entitled “SYSTEM AND METHODS FOR PERFORMING DISTRIBUTED PAYMENT TRANSACTIONS,” each of which are being filed simultaneously herewith, and are incorporated by reference herein, in their entirety.

### BACKGROUND OF THE INVENTION

1. Field of Invention

This invention relates generally to extending business interoperability to business entities, and, more particularly, to a secure system and a secure process for efficiently extending interoperability for communications and data related to transactions to business entities in an overall business sector, such as healthcare.

2. Related Art

Generally, the issues facing the healthcare industry include the continuing need for efficiency in each of the industry market verticals (“Vertical (s)”) such as clinics, hospitals, insurance payers, etc. and (b) the lack of effectiveness for transactions that occur across these vertical segments, affecting the entire healthcare market sector (“Sector”, or “Horizontal”.) The ability to effectively conduct business electronically, across and between these Verticals in the entire healthcare Sector is referred to as interoperability. Whereas solutions from various companies exist that attempt to make the Verticals more efficient, there is no solution in the marketplace that makes the overall market sector effective. Generally, efficiently means to do things right; effectively means to do the right things.

Looking into each of the two issues identified above it is noted: (a) Regarding the Vertical market segments, many companies have and continue to invest their resources and energies in making the Verticals more efficient through automation. This process is by no means complete, but the various market competitors continue to improve their products to deliver higher process efficiencies in each of these market segments. Examples of such companies are NextGen, GE Healthcare, Greenway Technologies, eClinicalWorks, Allscripts and others who have developed and market software solutions that increase the efficiency of clinics and medical offices. Similarly, corporations such as CERNER, SMS, McKesson and others have developed and market solutions that make hospitals more efficient. Others have done the same for other industry Verticals that contribute to the healthcare process, such as the insurance segment, the banking segment, the pharmacy segment, etc.

The lack of efficiency in the Vertical segments has been reviewed by the Institute of Medicine in the Untied States. On Mar. 1, 2001, the Institute of Medicine issued a report entitled Crossing the Chasm: A New Health System for the 21st Century that clearly describes the state of the healthcare industry in the United States. Specifically, this report states that the healthcare industry is in dire need of automation in all its operations, including hospitals, clinics and doctors in their practices (“Healthcare Providers”). This lack of automation causes healthcare to be expensive and inefficient, and it impedes the ability of healthcare providers to share electronically patient data, clinical and payment information. Such inefficiencies result not only in lost earnings (for example, it is estimated that in many cases as much as thirty percent (30%) of insurance claims are not paid because they cannot be processed due to improper coding), but also in exposure to potential legal liability that causes related insurance premiums to remain very high.

The present lack of Interoperability can be illustrated by the following quote from independent and credible third-party. The Health and Human Services (HHS) Secretary in 2006 said: “The US. health care system needs an interoperable electronic health records and billing system . . . I've come to conclude there really isn't a health care system. There's a health care sector . . . There's really nothing that connects it together into an economic system. ”

Furthermore, a federal statute governing the use of healthcare information, the Health Insurance Portability and Accountability Act of 1996, known as HIPAA, imposes federal requirements that affect healthcare providers and other covered entities. The regulations implementing HIPAA mandate certain changes that all healthcare providers must effect in their operations.

(b) Regarding the effectiveness of conducting business across the overall Sector, we note that there are numerous “Stakeholders” in the Healthcare Sector, including: Patients; Hospitals (including Urgent Care); Primary Physicians; Specialist Physicians; Pharmacies; Insurance Payers; Laboratories (for various tests, imaging, pulmonary, cardio, etc.); Pharmaceutical Companies; Banks that handle transaction payments including HAS/FSA accounts; Clearing Houses that negotiate a discounted network of services; Employers who participate in the payment of insurance premiums; Government that regulates and insures; and Associations that act as volume purchasing groups, such as Independent Physician Associations and Unions. Generally, a “Stakeholder” may be an individual, or corporation or other type of business who derives a business or personal benefit of any kind, and/or who contributes or participates in the delivery of healthcare services.

Whereas many companies are working hard to make each of these Stakeholders efficient (Verticals), there is no other solution in the marketplace that make the Horizontal processes effective (that is to say across the entire Healthcare Sector), at this time, nor is there a common infrastructure over which these stakeholders can conduct business effectively, in an automated way. In fact, it has been estimated that over 90% of some 30 billion healthcare transactions per year in the USA are paper based.

Moreover, there is a general mistrust among the key stakeholders, which is more or less natural in a market that is fraught with errors, fraud, inefficiency and shrinking margins. For example, in 2006, the head of the U.S. Department of Health and Human Services (HHS) has stated that in his estimate, that up to 25% of all Medicare transactions may be fraudulent.

This conflict is one of the main reasons why the various Stakeholders in healthcare do not collaborate, and hence the result is a disjointed, semi-automated and expensive healthcare delivery system, as illustrated in FIG. 1, where some of the Stakeholders are shown as pieces of a disjointed puzzle. That is, there is no common infrastructure among Stakeholders. Furthermore, because collaboration is important but not mandatory for effectiveness, it is difficult for anyone of the major players to play a leading role, due to objections by their competitors. For example, if a first large insurance company would take an initiative to resolve some of the key industry problems, why would a second insurance company collaborate and risk losing market share? The answer is likely they would not. It becomes obvious that the marketplace would favor an independent party, especially one that offers advantages to each of the healthcare stakeholders.

It should be noted that parts of the effectiveness solution are being addressed by initiatives that are typically sponsored by various States of the Union and referred to as Regional Health Information Organizations (“RHIO”), such RHIOs are generally concerned with and attempt to provide a standard with which to electronically share medical records with care providers, such as hospitals, clinics and physicians. In this RHIO environment, the participating Stakeholders are limited to healthcare providing entities, and the type of information they share is limited to medical records. But, this fails to address the needs of all types of Stakeholders, in all of the various products and services they require, including medical records. Examples of the additional products and services addressed by this invention include but are not limited to: Records and benefits individuals (and their families) derive from their membership in Associations; employment data, including detailed healthcare benefits; records and access to banking products of the individuals for healthcare related accounts, such as Health Savings Accounts and other financial matters, such as records for healthcare tax exemptions; records of medications individuals have been prescribed for and other related issues, such as whether they have purchased their medication, etc.

### SUMMARY OF THE INVENTION

The invention meets the foregoing need and allows a provider to be quickly and efficiently paid and the payor to quickly and efficiently receive documentation and the like, which results in a significant cost savings and other advantages apparent from the discussion herein.

More specifically, the invention provides a secure process system for the re-engineering of provider workflow which automates the workflow from start to end and allows for accurate, more time efficient medical processes and insurance claim settlement with more revenue.

According to one aspect of the invention, a process for an automated secure information exchange is provided. The process may include receiving information from at least one stakeholder, associating the information with an unique identification number, and generating results based upon the received information. The information may be received from different stakeholders. The stakeholder may include, for example, a patient, a physician, a clinic, a hospital, a pharmacy, an employer, an insurance company, government, or a consulting firm. The received information may include, for example, electronic medical records, individual health records, and electronic health record.

In another aspect of the invention, the process may include converting a foreign identification number to correlate the unique identification number generating by the secure process system of the invention.

In a further aspect, the process further includes updating the information and forwarding the updated information to an appropriate authorized stakeholder.

In a further aspect, the process may include associating the unique identification number with stakeholder demographic information. The demographic information may include, for example, social security number, biometric recognition data, addresses, phone numbers, age, race, gender, income, and employment status.

In yet a further aspect of the invention the generating step may produce an outcome report. The outcome report may provide depersonalized results of treatment and medication data of specific patients and aggregate clinical results. Additionally, the generating step may produce a report, such as a medical chart or an updated medical chart.

According to one aspect of the invention, a system for an automated secure information exchange is provided. The system may provide a means for receiving information from at least one stakeholder, a means for associating the information with an unique identification number, and a means for generating results based upon the received information. The information may be received from different stakeholders. The stakeholder may include, for example, a patient, a physician, a clinic, a hospital, a pharmacy, an employer, an insurance company, government, or a consulting firm. The received information may include, for example, electronic medical records, individual health records, and electronic health record.

In another aspect of the invention, the system may include a means for converting a foreign identification number to correlate the unique identification number generating by the secure process system of the invention.

In a further aspect, the system may include a means for updating the information and forwarding the updated information to an appropriate authorized stakeholder.

In a further aspect, the process may include associating the unique identification number with stakeholder demographic information. The demographic information may include, for example, social security number, biometric recognition data, addresses, phone numbers, age, race, gender, income, and employment status.

In yet a further aspect of the invention the generating means may produce an outcome report. The outcome report may provide depersonalized results of treatment and medication data of specific patients and aggregate clinical results. Additionally, the generating means may produce a report, such as a medical chart or an updated medical chart.

According to another aspect of the invention a system for an automated secure information exchange is provided. The system may receive information from at least one stakeholder, the system may associate the information with an unique identification number, and the system may generate results based upon the received information. In a further aspect, the system may further include a system to update the information and forward the updated information to an appropriate authorized stakeholder.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 is a diagram illustrating no common infrastructure among stakeholders.

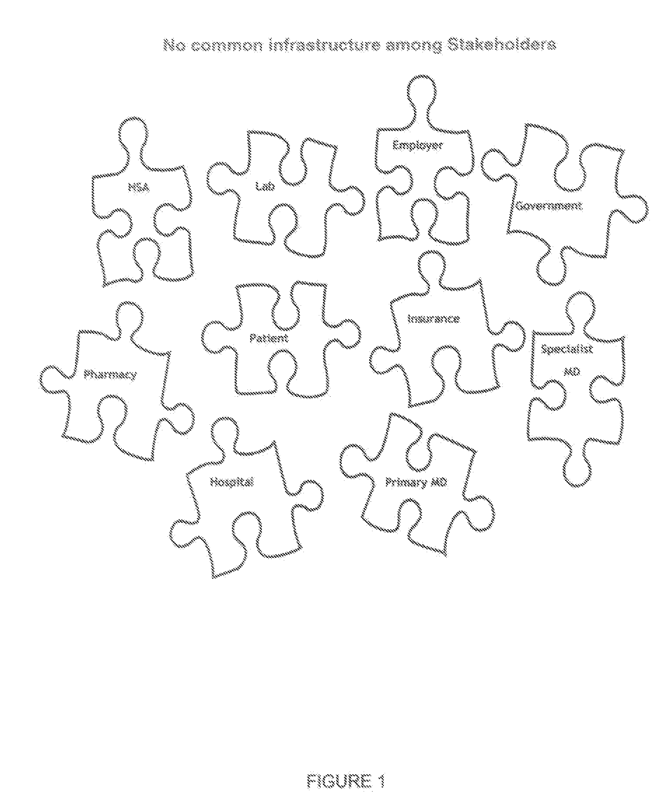

FIG. 2 is a diagram illustrating a provider workflow that is not completely automated from start to end.

FIG. 3 is a diagram illustrating a provider workflow that has been re-engineered using the system of the invention which has automated the workflow from start to end, according to the principles of the invention.

FIG. 4 is a diagram illustration a provider workflow that has been re-engineered by the system of the invention that is automated from start to end and maximizes cost efficiency and payment timeliness, according to an embodiment of the invention.

FIG. 5 is a diagram illustrating unique patient identification tracks outcomes from multiple physician-multiple claims.

FIG. 6 is a diagram illustrating the exchange server that enables unique participant identification tracking, according to principles of the invention.

FIG. 7 is a diagram illustrating the creation of individual health records prior to patient visitation with the provider according to principles of the invention.

FIG. 8 is a diagram illustrating the system of the invention.

FIG. 9 is a flowchart illustrating the system of the invention using a physician provider as an example.

### DETAILED DESCRIPTION OF THE INVENTION

It is understood that the present invention is not limited to the particular methodology, protocols, devices, apparatus, materials, and reagents, etc., described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include plural reference unless the context clearly dictates otherwise. Thus, for example, a reference to “process” is a reference to one or more processes and equivalents thereof known to those skilled in the art and so forth.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the present invention. All references cited herein are incorporated by reference herein in their entirety.

Moreover, provided immediately below is a “Definition” section, where certain terms related to the invention are defined specifically for clarity, but all of the definitions are consistent with how a skilled artisan would understand these terms. Particular methods, devices, and materials are described, although any methods and materials similar or equivalent to those described herein can be used in the practice or testing of the invention.

### Definitions

CPR is computerized patient record

ES is exchange server

EHR is electronic health record

EMR is electronic medical record

FIAF is financial institution advancing funds

TBS is toolbar system

FSA is flexible spending account

HSA is health savings account

HIPAA is Health Insurance Portability and Accountability Act of 1996

HHS is Health and Human Services

IHR is individual health record

ICD is International Statistical Classification of Diseases and Related Health Problems

ID is identification

LOC is line of credit

PIN is personal identification number

PC is personal computer

PMS is practice management system or physician management system

PPO is preferred provider organization or participating provider option

RHIO is Regional Health Information Organizations

SPS is secure process system

The term “demographics” as used herein generally refers to social security number, biometric recognition data, addresses, phone numbers, age, gender, race, income, educational attainment, home ownership, employment status, ethnicity, religion, life style, marital status, and the like.

The term “ICD” as used herein generally refers to codes used to classify diseases and a wide variety of signs, symptoms, abnormal findings, complaints, social circumstances and external causes of injury or disease. In generaly, every health condition can be assigned to a unique category and given a code, up to six characters long. Such categories can include a set of similar diseases. The ICD is used world-wide for morbidity and mortality statistics, reimbursement systems and automated decision support in medicine.

The term “provider” or “providers” as used herein generally refers to any health care provider, such as physicians, osteopathic doctors, medical doctors, podiatrists, chiropractors, nurse practitioners, nurses, physician assistants, dentists, pharmacies, hospices, hospitals, nursing homes, clinics, and the like.

The term “patient” as used herein, refers to an individual who may require detection and diagnosis of possible diseases, conditions, and/or disorders, such as hypercholesterolemia, diabetes, influenza, common cold, and hypertension and so on. The term patient, however, should not be construed to be limited to an individual afflicted with a condition or disease, but also those individuals seeking routine examines and physicals examinations. The term patient is also meant to include humans as well as animals.

The term “Stakeholder” as used herein generally refers to an entity such as a patient, physician, clinic, hospital, pharmacy, insurance company, bank, employer, pharmaceutical company, government, or consulting firm. Generally, a “Stakeholder” may be an individual, or corporation or other type of business who derives a business or personal benefit of any kind, and/or who contributes or participates in the delivery of healthcare services.

The term “baseline health data” as used herein generally refers to baseline health data including without limitation, cholesterol, white blood cell count, red blood cell count, hormone levels, triglycerides levels, platelet count, high density lipoproteins, low density lipoproteins, very low density lipoproteins, transaminase levels, and the like.

The term “outcomes” as used herein generally refers to data that show the results of treatment and medication of specific patients or aggregate clinical results with patient identities removed.

The term “clean claim” as used herein generally refers to a claim that properly verifies patient identification, supplies correct electronic coding for medical services and correctly appends all supporting evidence.

The invention relates to software algorithms which make up a secure processing system (SPS). The SPS algorithms reside and are embedded in the exchange server (ES) system, described in Assignee's U.S. application Ser. No. ______ , entitled “System and Method for Performing Distributed Transactions,” and the tool bar (TB) system, described in Assignee's U.S. application Ser. No. ______, entitled “Toolbar User Interface for Information System,” which are capable of re-engineering the business workflow processes of healthcare providers. The SPS of the invention is capable of re-engineering business by automating the workflow from start to end. Accordingly, by automating workflow, the SPS of the invention eliminates unsecured, un-automated workflow, thereby maximizing time, costs and other benefits.

In general, provider workflow processes suffer from lack of verification that all necessary steps required for the successful completion of a given part of the whole business process have indeed taken place prior to the end of a business transaction. This occurs due to the lack of complete end-to-end automation, where manual steps become necessary to complete the transaction and the continuing problem of staff at clinics and hospitals being inconsistent in the application of methods and procedures required to complete said processes due to errors or time/volume pressures. These include for example, (a) insurance claims submitted without adequate verification of the identity of the patient; (b) process of verifying the patient's insurance coverage and detailed eligibility for benefit coverage is often manual, by telephone. As a result, errors occur where people either mishear or mistype the codes, or when eligibility is simply not confirmed, but assumed due to an earlier encounter with that patient however the Patient may no longer be covered by that insurance. In any case, eventually the claim is rejected, the Provider has to pursue payment directly with the patient, and typically such collections do not become fulfilled approximately 30% of the time. Thus, reimbursement does not take place rapidly, or on occasion do not take place at all. (c) Patients get mis-labeled when admitted to hospitals due to human error, with serious, even catastrophic and lethal (on occasion) results. The secure processes of the invention would reduce significantly the probability of such errors.

Moreover, existing lack of automation in the healthcare industry necessitate repetition of activities, thus increasing cost and inefficiency, as well as increasing the probability of errors. Some examples of this condition are: (a) Registration processes are repeated, as patients are referred to an are sent from one physician to another in a different specialty, or patients are sent to Labs for tests, or they are sent to be admitted to a hospital, etc. (b) Patients misplace their prescriptions and they have to be re-issued, at a cost of time and effort by clinical staff who have to identify not only if the right prescription has been already filled, but also to confirm that the same or different medication should be administered as time has elapsed and the condition of the patient may have worsened. (c) manual claims preparation may have to be repeated if the paper work is misplaced, and the like.

In healthcare, it is often the case that various related processes take place in parallel. If such processes get out of synchronization, errors, delays and denials of reimbursement may occur. Claims often require supporting evidence, in the form of lab tests, signed x-rays (for confirmation that it was in fact seen and used by the attending Physician) and the like. In such cases, manual processes fail when the parallel steps get out of sync, as for example if the claim arrives at the insurance for payment, electronically, but the x-ray that justifies the specific level of payment is lost in the mail, or arrives too late for the claim to be paid, or for another example, the lab tests show the insurance will not cover a given procedure, but the procedure has been done, and now the patient must be asked (a few months later) to pay for something they thought was covered but now it is claimed from the patient, while the patient does not understand the reasons and explanations of why the patient needs to pay.

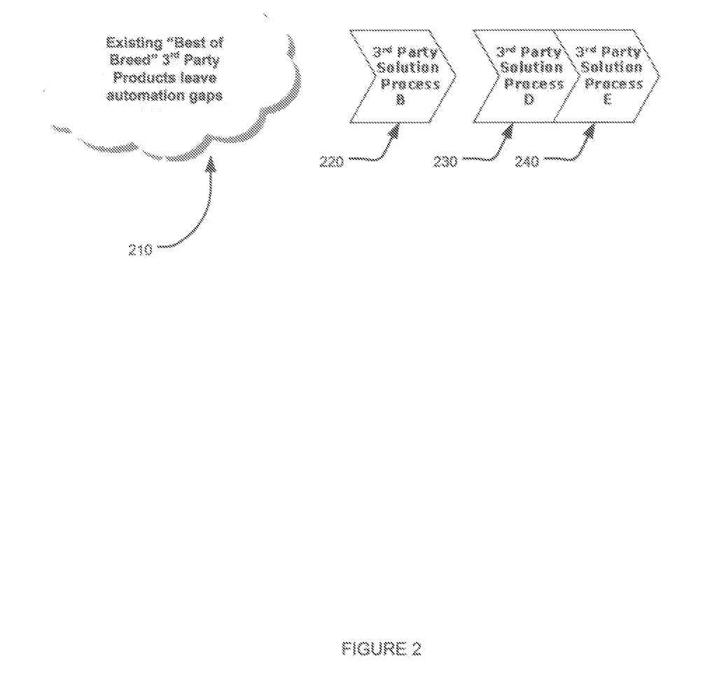

For example, FIG. 2 illustrates a typical workflow process at a clinic, which does not have complete end to end automation of the workflow. Referring to FIG. 2, 210 represents third party products, 220 is a third party solution process (B), 230 is a third party solution process (D), and 240 is a third party solution process (E). As seen in FIG. 2, third party Electronic and Health Record systems 210 leave workflow automation “gaps,” such as the gap shown between third party solution process 220 and third party solution process 230. These un-automated workflow gaps may include, without limitation, manual verification of insurance eligibility via telephone, un-automated verification of patient identity, opposed to biometric identification, unavailability of health data, such as base line and historical patient data, to assist in the diagnosis and determination of suitable treatment regimens, and no pre-determination of the patient's insurance payment.

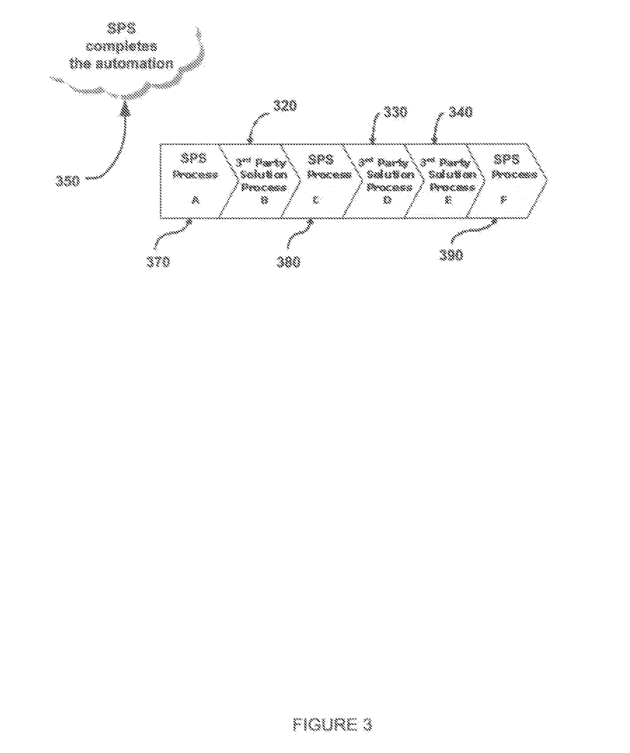

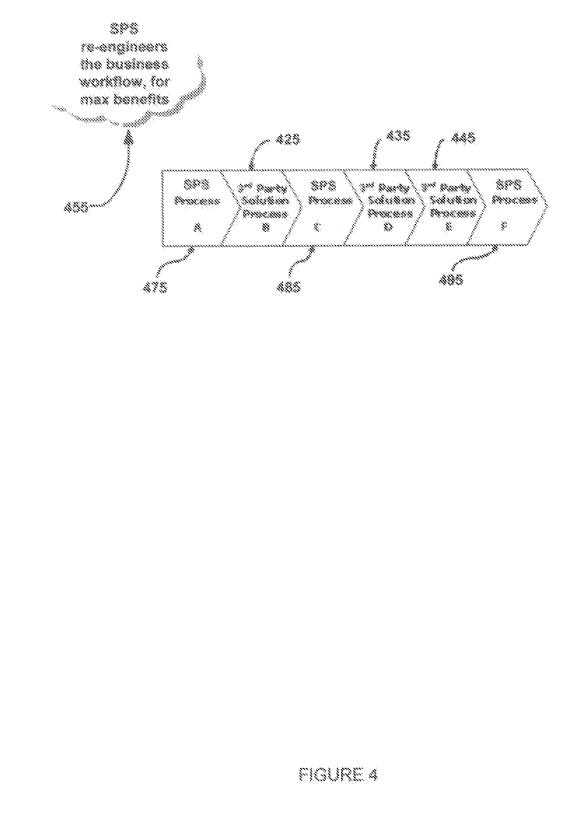

The EE and ETB systems in combination with the SPS of the invention introduce software steps that secure the accuracy, timeliness and completion of business processes. The SPS of the invention may re-engineer the business workflow by integration of the un-automated workflow gaps thereby enhancing the efficiency of the existing systems and streamlines the business workflows of medical practices and clinics as depicted in FIGS. 3 and 4. FIG. 3 shows additional functionality added to the clinic by automating the workflow. Specifically, for example, the automation identifies insurance eligibility resulting in elimination of telephone calls to perform this task thereby yielding a 10 to 15 minute gain in the time it typically takes to process and register a patient.

Turning to FIG. 3, which illustrates another embodiment of the invention. FIG. 3 illustrates a situation where a patient or individual is not part of the system 350, that is, the individual is from a completely different system or solution and cannot access the system. However, the individual may access the translation 320 from which they can now enter into the master database. The translation algorithm allows the system to collect information from other family solution products. After the information has been collected via the translation 321, the SPS of the invention may continue to automate the workflow between process B 370, process D 380 and process E 390.

Referring to FIG. 4, which illustrates how provider business workflows may be improved through the automation using the SPS of the invention to maximize costs and timeliness of payment and payment collection. For example, process A 475 may be used in combination with process C 485 and process F 495 to fully automate the workflow process form start to end.

Another workflow advantage that re-engineers the processes of a medical practice is that SPS may be used to predetermine the value of the payment from the insurance payer and additionally to predetermine the payment amount that is the responsibility of the patient. This may be accomplished while the patient is at the provider's office thereby eliminating all future payment steps such as billing and mailing, and determination of primary and secondary insurance coverage. Therefore, all insurance payments may be settled at the patient's discharge time.

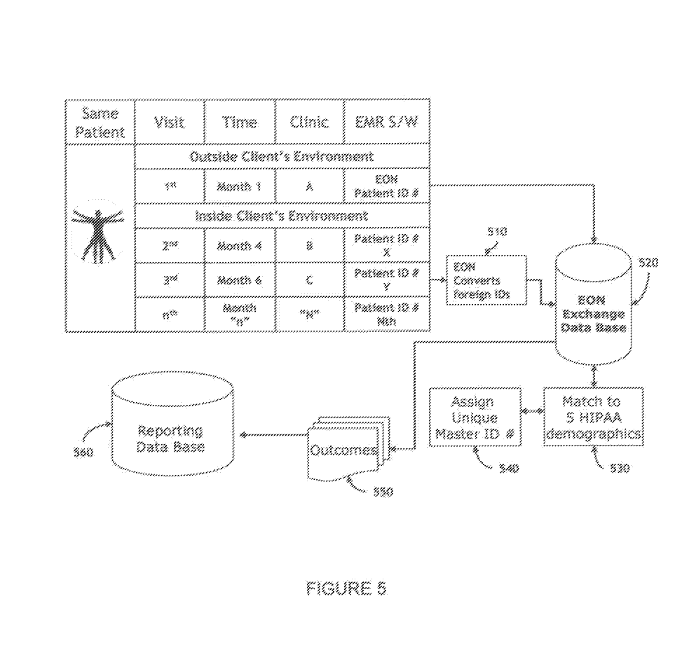

FIG. 5 depicts how the same patient may have multiple visits to different stakeholders at different points in time. For example, the patient first visits the 1^{st} clinic because that is the individual's primary care doctor. The primary case doctor refers the patient to a specialist and the patient visits the 2^{nd} clinic and so on up to the nth clinic. However, the secure process in place 510 ensures the patient identification (ID) number generated by the system is unique and maintained in the Exchange 520, such that the patient is uniquely identified according to HIPAA parameters 530 and all services rendered to that patient can now be matched correctly to that patient, outcomes 550 can be tabulated and assigned separate ID numbers 540, so as to maintain the confidentiality of the ID of the patient and then reported 560 to the interested government or healthcare industry parties in general statistical format.

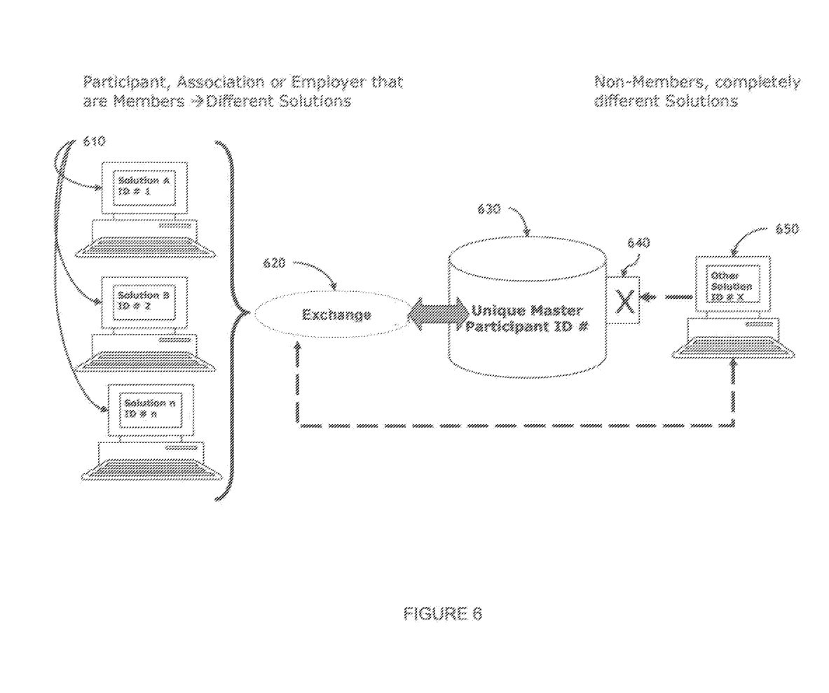

FIG. 6, which illustrates and embodiment of the invention, shows different user devices 610 to be used by different Stakeholders that are members of the system (but have different software solutions in place) being able to be assigned the same “master participant ID” 630 by the Exchange 620; while non-members with completely different solutions 650 cannot have 640 the same master participant ID, unless they are connected to the Exchange.

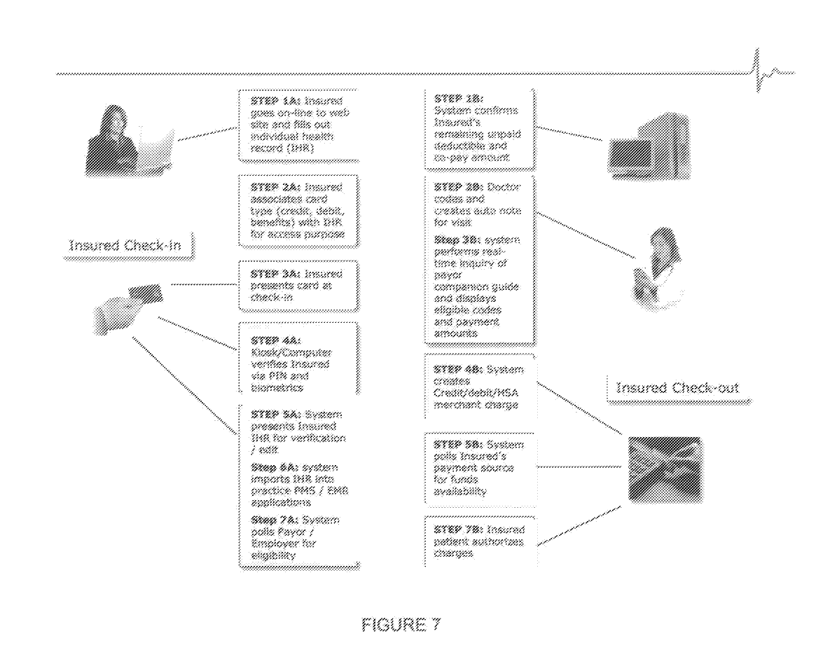

In one embodiment, FIG. 7 shows the key steps that occur in the execution of the secure process, using a patient encounter with a Physician, as an example. FIG. 7 is a flow diagram showing steps of an embodiment of the invention, starting at step 1A. FIG. 7, as well as any other flow diagram herein, may equally represent a high-level block diagram of components of the invention implementing the steps thereof. All or a subset of the steps of FIG. 7, and all the other flow diagrams, herein, may be implemented in computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Further, the computer code may also be embodied, at least in part, in a medium such as a carrier wave, which can be extracted and processed by a computer. Additionally, the computer program code and any associated parametric data can be transferred to a workstation over the Internet or some other type of network, perhaps encrypted, using a browser and/or using a carrier wave. The flowchart of FIG. 7 will now be described in greater detail below.

In step 1A, the insured accesses the system website and fills out individual health record (IHR). Subsequently, in step 1B, the system confirms the insured's remaining unpaid deductible and co-pay amount. In step 2A, the insured associates card type, such as credit card, debit card, and/or benefits card with IHR for access purposes. In step 2B, the system creates doctor codes and creates auto note for visitation. In step 3, the insured present card at check-in at provider's office. In step 3B, the system performs realtime inquiry of payor companion guide and displays eligible codes and payment amounts. In step 4A, the kiosk and/or computer verifies insured through PIN number and biometrics. The biometric recognition may include without limitation, retinal recognition, fingerprint recognition, facial feature recognition, and iris recognition. In step 4B the system creates a credit, HAS, and/or debit merchant charge. In step 5A, the system presents insured IHR for verification or revision by the provider. In step 5B, the system polls the insured's payment source for funds availability. In step 6A, the system imports IHR into practice PMS and/or EMR applications. In step 7A, the system polls the payor and or employer for eligibility. In step 7B, insured patient authorizes charges. While a process according to principles of the invention has been described in FIG. 7, it is understood that additional steps may be added to the process, steps may be omitted from the process and/or steps may be performed in a different order without departing from the scope of the invention.

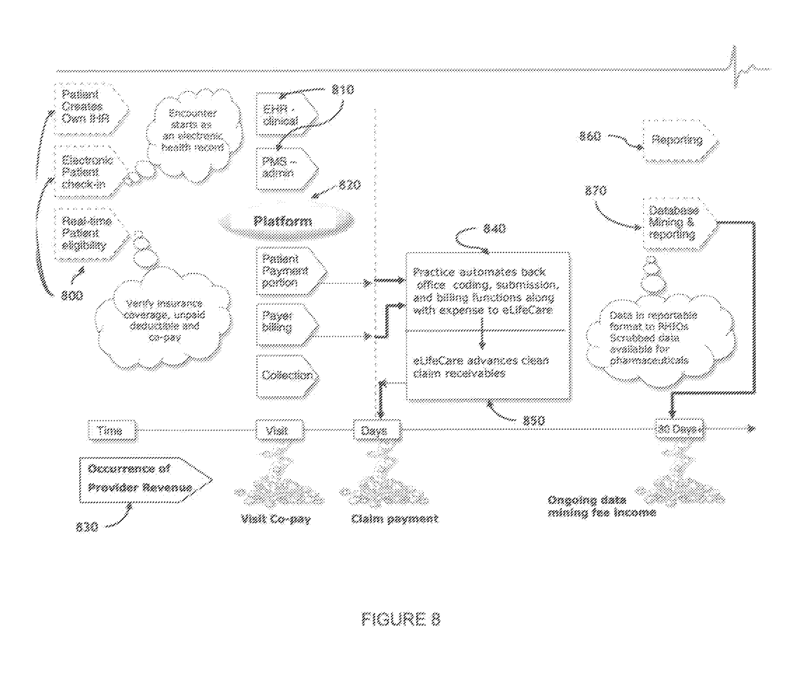

FIG. 8, which illustrates an embodiment of the invention, shows how SPS of the invention may create clean claims and thereafter payment can be advanced within 24 hours from the time of service (shorter by orders of magnitude from existing practices.) In FIG. 8, item 800 shows examples of various actions that occur before the time of the encounter visit, 810 and 820 show the Practice Management and Electronic Medical Record Systems by third parties that are installed at some clinic, 840 and 850 show the system adjudication process, while 860 and 870 show the results of the process generating reports and monetizing of the de-personalized data accumulated. Numeral 830 shows the time lapsed between when events occur and payment is made to the provider. Since every step of the process is automated, the information is secure.

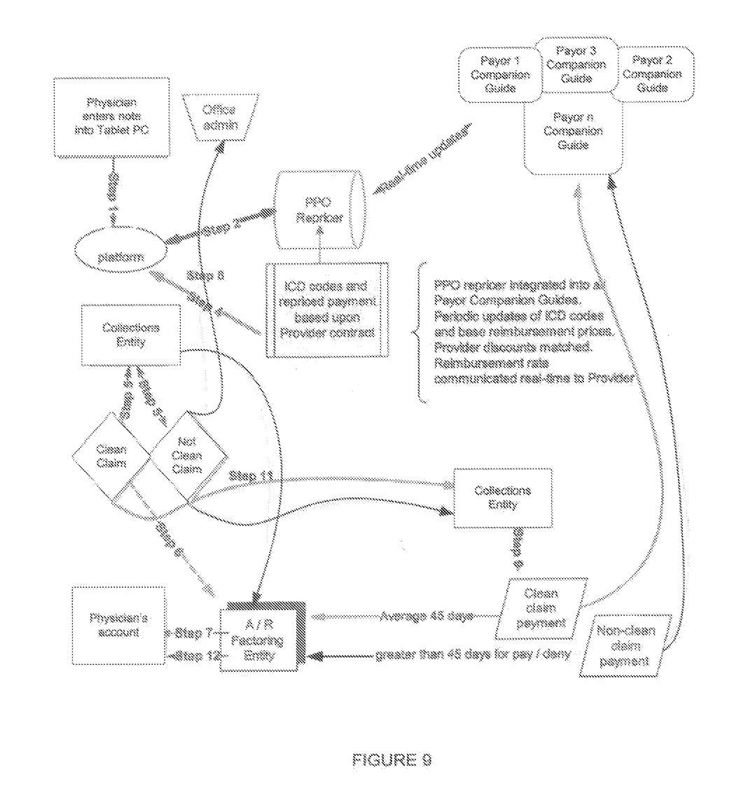

The flowchart depicted in FIG. 9, which illustrates an embodiment of the invention, shows the Secure Process workflow steps that create clean claims as a result of which the Provider can get paid within 24 hours. The flowchart of FIG. 9 will now be described in greater detail below.

In step 1, the physician provides services and then enters ICD codes and notes into tablet PC. In step 2, the tablet PC is integrated into the platform for realtime routing of ICS codes to PPO repricer during patient visit prior to patient check-out. In step 3, the PPO repricer searches the database for match of payor, payor companion guide and base ICD code payment rates and sorts into clean and other claims. In step 4, the PPO repricer computes provider discount for all ICD codes and send the information back to the platform. In step 5, the system send clean and other claims to FIAF entity and collections entity. In step 6, the factoring entity checks available funds in physician LOC. In step 7, the factoring entity processes clean claims and transfers amount into physician's account within about 24 hours. In step 8, the other claim services and the monetary compensation are sent to the physician check out station for patient charge authorization and suspension until claim payment is resolved with payor. In step 9, the collection entity imitates claim to payor for clean charges and supplemental claim for other charges. In step 10, when the other claim payment is resolved with the payor, the collections entity deletes or processes the suspended charge in step 8. In step 11, the record is sent to FIAF entity. In step 12, the clean claims amount denied by payor are charges back on a daily basis and netted form the amount advanced in step 7.

The invention has been disclosed broadly and illustrated in reference to representative embodiments described above. Those skilled in the art will recognize that various modifications can be made to the present invention without departing from the spirit and scope thereof. Without further elaboration, it is believed that one skilled in the art, using the preceding description, can utilize the present invention to the fullest extent.

What is claimed is:

1. A process for an automated secure information exchange, said process comprising the steps of:
receiving information from at least one stakeholder;
associating the information with an unique identification number; and
generating results based upon the received information.

2. The process of claim 1, further comprising the steps of updating the information and forwarding the updated information to an appropriate authorized stakeholder.

3. The process of claim 1, wherein said at least one stakeholder is an entity selected from the group consisting of a patient, a physician, a clinic, a hospital, a pharmacy, an employer, an insurance company, government, or a consulting firm.

4. The process of claim 1, wherein said receiving step comprises receiving information from different stakeholders.

5. The process of claim 1, wherein the received information is information selected from the group consisting of an electronic medical record, electronic health record, and an individual health record.

6. The process of claim 1, further comprising the step of converting a foreign identification number to correlate with the unique identification number.

7. The process of claim 1, further comprising the step of associating the unique identification number with stakeholder demographic information.

8. The process of claim 7, wherein said demographic information is information selected from the group consisting of social security number, biometric recognition data, addresses, phone numbers, age, race, gender, income, and employment status.

9. The process of claim 1, wherein said generating step produces an outcome report.

10. The process of claim 9, wherein said outcome report is a report providing depersonalized results of treatment and medication of specific patients and aggregate clinical results.

11. The process of claim 1, wherein said generating step produces a report.

12. The process of claim 11, wherein said report is a medical chart.

13. The process of claim 11, wherein said report is an updated medical chart.

14. The process of claim 1, wherein said generating results step produces a clean claim.

15. A system for an automated secure information exchange, said system comprising:
means for receiving information from at least one stakeholder;
means for associating the information with an unique identification number; and
means for generating results based upon the received information.

16. The process of claim 15, further comprising a means for updating the information and forwarding the updated information to an appropriate authorized stakeholder.

17. The system of claim 15, wherein said at least one stakeholder is an entity selected from the group consisting of a patient, a physician, a clinic, a hospital, a pharmacy, an employer, an insurance company, government, or a consulting firm.

18. The system of claim 15, wherein said receiving means receives information from different stakeholders.

19. The system of claim 15, wherein the received information is information selected from the group consisting of an electronic medical record, electronic health record, and an individual health record.

20. The system of claim 15, further comprising means for converting a foreign identification number to correlate with the unique identification number.

21. The system of claim 15, further comprising means for associating the unique identification number with stakeholder demographic information.

22. The system of claim 21, wherein said demographic information is information selected from the group consisting of social security number, biometric recognition data, addresses, phone numbers, age, race, gender, income, and employment status.

23. The system of claim 15, wherein said generating means produces an outcome report.

24. The system of claim 23, wherein said outcome report is a report providing depersonalized results of treatment and medication of specific patients and aggregate clinical results.

25. The system of claim 15, wherein said generating means produces a report.

26. The system of claim 25, wherein said report is a medical chart.

27. The system of claim 25, wherein the report is an updated medical chart.

28. The system of claim 15, wherein said generating means produces a clean claim.

29. A system for an automated secure information exchange, said system comprising:
system to receive information from at least one stakeholder;
said system to associate the information with an unique identification number; and
said system to generate results based upon the received information.

30. The system of claim 29, further comprises a system to update the information and forward the updated information to an appropriate authorized stakeholder.

31. The system of claim 29, wherein said at least one stakeholder is an entity selected from the group consisting of a patient, a physician, a clinic, a hospital, a pharmacy, an employer, an insurance company, government, or a consulting firm.

32. The system of claim 29, wherein said system receives information from different stakeholders.

33. The system of claim 29, wherein the received information is information selected from the group consisting of an electronic medical record, electronic health record, and an individual health record.

34. The system of claim 29, further comprises a system for converting a foreign identification number to correlate with the unique identification number.

35. The system of claim 29, further a system for associating the unique identification number with stakeholder demographic information.

36. The system of claim 35, wherein said demographic information is information selected from the group consisting of social security number, biometric recognition data, addresses, phone numbers, age, race, gender, income, and employment status.

37. The system of claim 29, wherein said system produces an outcome report.

38. The system of claim 37, wherein said outcome report is a report providing depersonalized results of treatment and medication of specific patients and aggregate clinical results.

39. The system of claim 29, wherein said system produces a report.

40. The system of claim 39, wherein said report is a medical chart.

41. The system of claim 39 wherein said report is an updated medical record.

42. The system of claim 29, wherein said system produces a clean claim.
